(19) United States
(12) Patent Application Publication
(10) Pub. No.: US 2010/0195318 A1
(43) Pub. Date: Aug. 5, 2010

(54) Reusable Accent Light and Method of Using the Same

(76) Inventor: Wayne H. Jones, Rigby, ID (US)

Correspondence Address: PEDERSEN & COMPANY, PLLC, P.O. BOX 2666, BOISE, ID, 83701, US

(21) Appl. No.: 12/366,109

(22) Filed: Feb. 5, 2009

(51) Int. Cl. F21L 4/04

(52) U.S. Cl. 362/157

(57) ABSTRACT

An accent light includes a case body, a pair of spaced apart batteries connected to supply electrical power to an LED, and a contact bearing which is selectively insertable into and withdrawable from between the spaced apart batteries to complete an electrical circuit through the LED. A hook extends from the case body to support the accent light. The accent light may be used when submerged in water for a reasonable longevity despite the water surrounding the batteries.

This invention relates to small light emitting devices, sometimes referred to as accent lights, that are typically used to illuminate and enhance arts and crafts, floral arrangements, and other decorative objects. More particularly, the present invention relates to a new and improved accent light and method of using the accent light which is easy to use, relatively inexpensive to purchase and produce, easy to operate and convenient to attach to a floral arrangement, decoration or other object for illuminating purposes.

### BACKGROUND OF THE INVENTION

The appearance of many arts and craft products, floral arrangements, art objects, arts and crafts and other similar decorative objects, referred to as “decorations” herein, is sometimes enhanced by the thoughtful placement of a small light source which projects light to illuminate all or a portion of the decorations. Such a light source is known as an accent light. The illumination of decorations with one or more thoughtfully placed accent lights can result in an appealing visual effect.

A typical accent light uses a small light source such as a miniature light bulb or a light emitting diode (LED), one or more batteries, a housing or some other structure which contains the components, and some form of activation device which closes the electrical circuit between the batteries and the light source to initiate generation and projection of the light. LEDs are more advantageous for use than miniature light bulbs because LEDs are more easily powered by the batteries. LEDs may also be more reliable and useful in some environments in which accent lights are used.

Currently available accent lights are relatively inexpensive in an overall sense, but when the size, appearance, utility and longevity of use of such devices are considered, the overall cost is regarded by many consumers as relatively expensive. This expense reflects a relatively high cost to manufacture these accent lights, arising principally from a relatively high cost to assemble components into the accent lights. The high cost of assembly results from the construction characteristics of the previous accent lights.

One commercially available accent light includes a pair of disc-shaped batteries stacked on one another. Contact leads of an LED are soldered or welded to opposite surfaces of the battery stack. The batteries and the LED are held together by thermal shrink wrap material. A strip of electrically insulating paper initially separates the two batteries at the location where the battery surfaces are adjacent to one another. The accent light is turned on by pulling the strip of paper out from between the batteries and the shrink wrap material, which completes a electrical circuit between the batteries and through the LED, thus causing the LED to emit light.

The assembly costs of this type of accent light are significant. Extra cost is involved in soldering or welding the leads of the LED to the batteries. Significant time is required to assemble the components in position, and to hold those assembled components while the shrink wrap material is shrunk around those components to permanently hold them in position. The appearance of the shrink wrap material around the components is not appealing from an artistic or visual standpoint, because the shrink wrap material covers and reveals the industrial shapes of the components used. Because of the lack of artistic or visual appeal, this type of accent light must usually be concealed from view in the decorations. Furthermore, the external shrink wrap covering provides no capability to assist in mounting or retaining the accent light at a desired location within the decorations. This accent light also lacks reusability since it is impossible to replace the batteries when discharged. Replacing the batteries involves destroying the shrink wrap covering, which would disassemble the components of the accent light to the point where they cannot be reassembled. It is also impossible to turn the light on and off, because once the device has been activated by removing the paper from between the batteries, there is no capability to reinsert the paper or to otherwise separate the batteries to open the electrical circuit. Thus, once activated, the device will continue to emit light until the batteries discharge. Furthermore, if the free end of the paper strip happens to be come torn off without removing the remaining portion of the paper strip which separates the batteries, there is no capability to thereafter activate the accent light, because there is no ability to remove the paper separating the batteries. When purchasing the accent light, the consumer has no capability to determine whether the paper strip will inadvertently tear loose from the remainder of the strip separating the batteries.

While other accent lights may have somewhat different constructions and features, many of the above-described disadvantages are thought to be typical in the construction and use of previous accent lights. These and other considerations have led to the present invention.

### SUMMARY OF THE INVENTION

The present invention responds to the need for a more useful, relatively less expensive and more attractive accent light. The present accent light is organized and constructed to facilitate assembly in a relatively minimal amount of time, thereby reducing its cost. The present accent light is attractively shaped to allow the accent light to be used in many different decorative environments, without the need to conceal it, as is the case with previous unattractive accent lights. The accent light may be easily attached or connected to, or used with, a wide variety of decorations. The batteries within the accent light are replaceable, and the light can be repeatedly and selectively turned on and off when desired. The accent light may also be used when submerged in water environments to provide accent light in those circumstances.

In accordance with these considerations, one aspect of the invention involves an accent light that includes a case body, an LED and two batteries positioned within an interior space of the case body. The batteries occupy a spaced apart relationship, in which each battery has spaced apart opposing surfaces of opposite polarity. One surface of each battery is in contact with a contact lead of the LED, and the other surfaces of each battery are spaced part from one another. A switch, which includes a contact bearing, is moveable between an open position and a closed position. The open position locates the contact bearing out of electrical contact with the spaced apart opposing surfaces of the batteries, and the closed position locates the contact bearing in electrical contact with the spaced apart and opposing surfaces of the batteries to complete an electrical circuit through the contact bearing, the batteries, and the leads of the LED, thereby illuminating the LED.

Other aspects of the accent light involve projections within the case body which separate the batteries from one another and which maintain the battery surfaces in contact with the leads of the LED, separating the battery surfaces by a distance less than the transverse dimension of the contact bearing to assure that its insertion establishes a good electrical connection, a groove on the inside surface of the case body to receive a lead of the LED to maintain the lead in position in contact with each battery, a case cap connected to the case body and an elongated switch slide which extends through an opening in the case cap and which is slidable to insert and withdraw the contact bearing from between the spaced apart battery surfaces, a stop tang on the slide switch which prevents its movement unless selectively deflected by the user, a ring formed at an exterior end of the switch by which to support the accent light, a hook extending from the case body by which to support the accent light, and a retaining opening formed in the hook by which to support the accent light.

Another aspect of the invention involves a method of activating an accent light having two spaced apart batteries which are connected to supply electrical power to an LED, the batteries each having exterior surfaces, one surface of each battery occupying a spaced apart opposing relationship with a surface of the other battery. The method involves selectively inserting a conductive contact bearing between the spaced apart opposing surfaces of the batteries to complete an electrical circuit through the batteries and conduct the electrical power to the LED, and selectively withdrawing the contact bearing from between the spaced apart opposing surfaces of the batteries to open the electrical circuit through the batteries and discontinue conducting electrical power to the LED. Other aspects of the method involve depressing a switch slide longitudinally into the case body to insert the contact bearing between the spaced apart opposing surfaces of the batteries, and extending the switch slide longitudinally from the case body to withdraw the contact bearing from between the spaced apart opposing surfaces of the batteries.

One additional aspect of the invention involves a method of using an accent light of the type having two spaced apart batteries which are connected to supply electrical power to an LED. The batteries and the LED are connected to a case body which is not sealed. The method comprises submerging the accent light within water while the batteries supply electrical power sufficient to illuminate the LED, permitting water to enter the case body and surround the batteries and the LED while the batteries supply electrical power to the LED, and illuminating the LED from power supplied by the batteries for a predetermined amount of time greater than the amount of time that the batteries would supply electrical power if the batteries were electrically short-circuited.

A more complete appreciation of the present invention and its scope may be obtained from the accompanying drawings, which are briefly summarized below, from the following detailed description of a presently preferred embodiment of the invention, and from the appended claims.

### BRIEF DESCRIPTION OF THE DRAWINGS

FIG. 1 is a perspective view of an accent light which embodies the present invention.

FIG. 2 is an exploded perspective view of the accent light shown in FIG. 1.

FIG. 3 is a longitudinal cross-sectional view of the accent light shown in FIG. 1 taken parallel to a bell-shaped exterior surface of a housing of the accent light shown in FIGS. 1 and 2.

FIG. 4 is a transverse cross-sectional view of the accent light shown in FIG. 1, taken substantially in the plane of line 4-4 in FIG. 3.

FIG. 5 is a longitudinal cross-sectional view of the accent light shown in FIG. 1, taken substantially in the plane of line 5-5 in FIG. 3, with portions of a switch slide of the accent light removed for clarity, and showing the switch slide in an open position.

FIG. 6 is a cross-sectional view similar to FIG. 5, showing the switch slide moved to an intermediate position from the open position shown in FIG. 5.

FIG. 7 is a cross-sectional view similar to FIGS. 5 and 6, showing the switch slide moved to a closed position from the intermediate position shown in FIG. 6.

FIG. 8 is a schematic circuit diagram of an electrical circuit which is selectively established by moving the switch slide to the position shown in FIG. 7.

FIG. 9 is a a partial, enlarged cross-sectional view of a contact bearing and a bore retaining the contact bearing, taken substantially in the plane of line 9-9 in FIG. 3.

FIG. 10 is a perspective view showing examples of use of the accent light shown in FIGS. 1-7, in connection with a and a flower arrangement.

FIG. 11 is a perspective view showing another example of use of the accent light shown in FIGS. 1-7, submerged within water.

### DETAILED DESCRIPTION

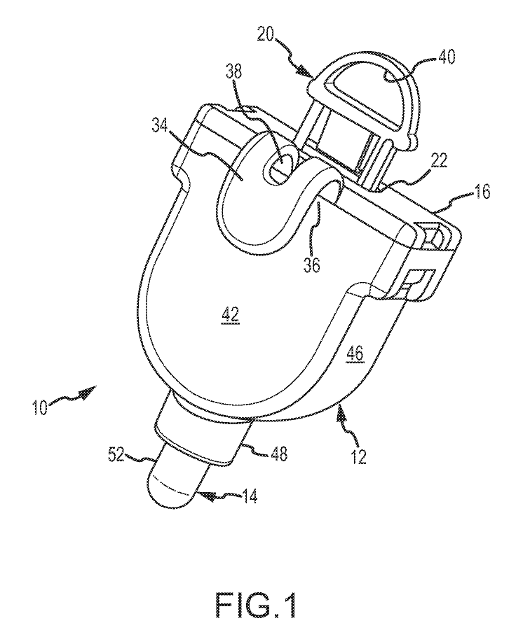

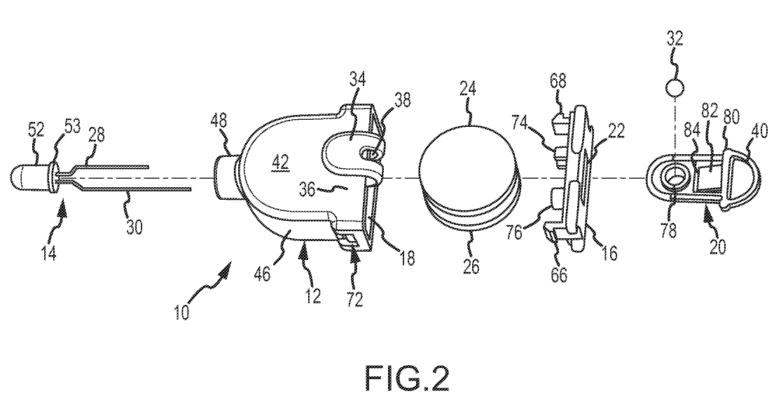

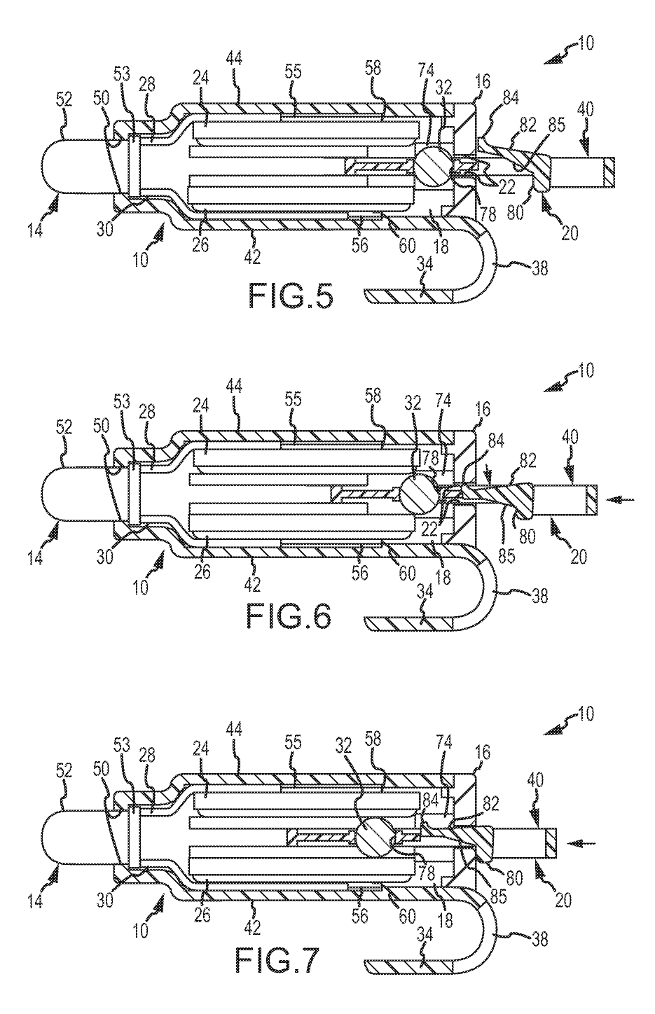

An accent light 10 incorporating the present invention is shown in FIGS. 1 and 2. The accent light 10 has a case body 12 from which a light emitting diode (LED) 14 extends at one end. A case cap 16 is connected to the opposite end of the case body 12 from the LED 14. The case cap 16 closes an interior space 18 defined by the case body 12. A switch slide 20 extends through a rectangular opening 22 formed in the case cap 16. The switch slide 20 is movable through the rectangular opening 22 from an extended position (FIGS. 1 and 5) to a depressed position (FIG. 7). Batteries 24 and 26 are retained within the interior space 18. Leads 28 and 30 of the LED 14 contact the batteries 24 and 26, respectively. A circularly-shaped and electrically-conductive contact bearing 32 is retained by and carried at an inner end of the switch slide 20.

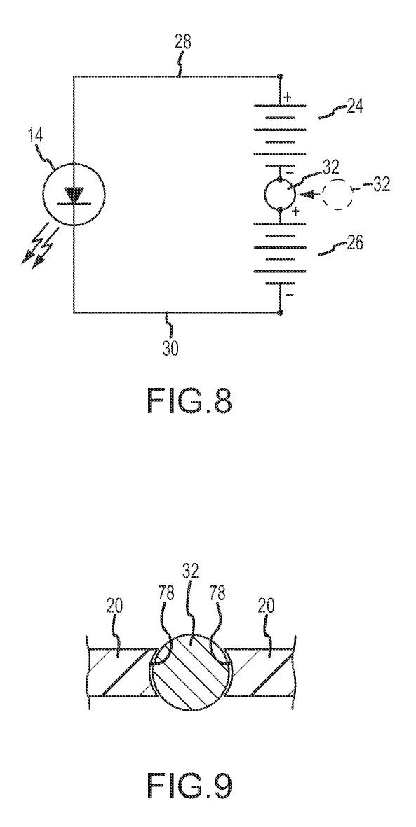

When the switch slide 20 is depressed, the contact bearing 32 contacts the two batteries 26 and 28 and completes an electrical circuit between the batteries 26 and 28. The completed electrical circuit is shown in FIG. 8. The electrical circuit conducts current from the batteries 26 and 28 to the LED 14 through the leads 28 and 30 and causes the LED 14 to emit light. Depressing the switch slide 20 into the case body 12 turns on the LED 14, thus activating the accent light 10. Pulling the switch slide 20 from the depressed position to the extended position turns off the LED 14, thus deactivating the accent light 10. Thus, the accent light 10 is selectively activated and selectively deactivated by depressing and withdrawing the switch slide 20, as desired by the user.

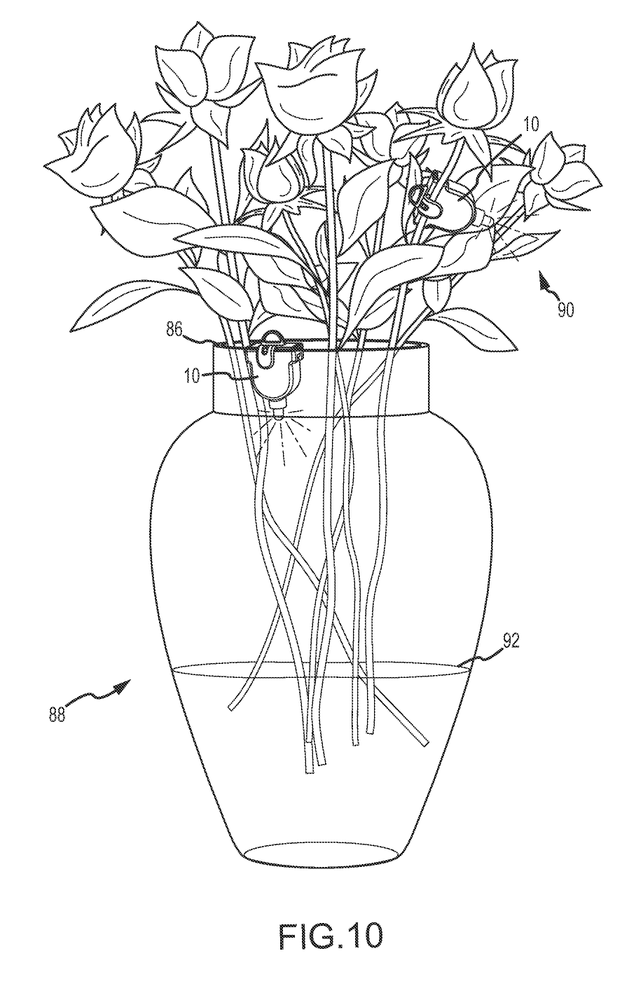

A hook 34 extends from the case body in a U-shaped configuration. The U-shaped hook 34 surrounds a space 36 into which a structure may be inserted to retain the accent light 10 in a desired position (e.g., FIG. 10). The hook 34 is slightly deformable to press firmly against the structure inserted into the space 36 between the hook 34 and the case body 12. The accent light 10 can also be held in place or suspended by use of an opening 38 formed in the hook 34 and/or a ring 40 formed on the outer end of the switch slide 20. A piece of string or other retainer is passed through the attachment opening 38 or through the ring 40 to hold the accent light 10 in a desired position.

The case body 12 is preferably formed of injection molded plastic in a configuration which has two, flat, opposite and parallel-extending bell-shaped top and bottom sides 42 and 44, respectively, which are separated by a constant-width sidewall 46 that is connected to the bell-shaped sides 42 and 44 at edges.

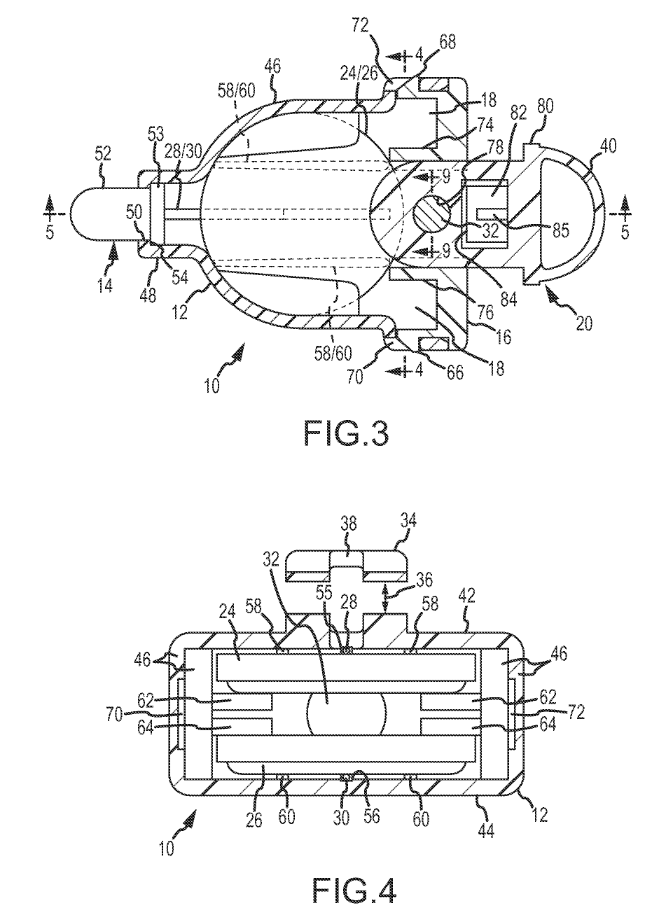

An annular protrusion 48 extends from the case body 12 at a location which is opposite from the case cap 16. The annular protrusion 48 defines a circular opening 50 into the interior space 18. A lens portion 52 of the LED 14 extends through the circular opening 50, as shown in FIGS. 3 and 5-7. A base portion 53 of the LED 14, which is connected to the lens portion 52, abuts against a lip 54 of the annular protrusion 48 and prevents the LED 14 from moving out of the case body 12 through the circular opening 50.

The leads 28 and 30 from the LED 14 extend into grooves 55 and 56 which are formed in the inner surfaces of the bell-shaped side 42 and 44 which face the interior space 18, respectively, as shown in FIGS. 3 and 4. The inner surfaces of the bell-shaped sides 42 and 44 also include ridges 58 and 60, respectively. The ridges 58 and 60 extend parallel to the grooves 55 and 56 at a position laterally spaced to the outside on opposite sides of the grooves 55 and 56. Ledges 62 and 64 both extend into the interior space 18 from opposite interior surfaces of the sidewall 46. The ledges 62 and 64 support the batteries 24 and 26, respectively. When the batteries 24 and 26 are inserted within the interior space 18 of the case body 12, the ledge 62 contacts the lower surface of the battery 24 while the ridges 58 contact the upper surface of the battery 24. Similarly, the ledge 64 contacts the upper surface of the battery 26 and the ridges 60 contact the lower surface of the battery 26. The vertical clearance between the ridges 58 and 60 and the ledges 62 and 64 is slightly less than the vertical thickness of the batteries 24 and 26, respectively, between their upper and lower surfaces. The slight difference in vertical clearance slightly deforms the case body 12 to create a retention force to maintain the batteries in position when inserted into the interior space 18.

In addition, the retention of the batteries 24 and 26 simultaneously establishes and maintains an electrical connection between the batteries 24 and 26 and the leads 28 and 30 of the LED 14 located in the grooves 55 and 56. The vertical clearance space between the upper surface of the battery 24 and the deepest portion of the groove 55, and the vertical clearance space between the lower surface of the battery 26 and the deepest portion of the groove 56, is each slightly less than the diameter or thickness of the leads 28 and 30. As a consequence, a retention force is established between the upper surface of the battery 24 and the lead 28 in the groove 55 and between the lower surface of the battery 26 and the lead 30 in the groove 56. Again the retention force is due to a slight deformation of the case body 12 resulting from the described physical dimensions. This retention force maintains a good continuous electrical contact connection between the leads 28 and 30 and the batteries 24 and 26 without necessity for soldering or welding the leads 28 and 30 to the surfaces of the batteries 24 and 26. The retention of the LED leads 28 and 30 in the grooves 55 and 56 also holds the LED 14 in position within the circular opening 50 of the annular protrusion 48 without the need of any further retaining structure or adhesive.

The top and bottom portions or surfaces of each battery 24 and 26 constitute an electrical contact of respectively opposite polarity. The lead 28 contacts the top surface (as shown) of the battery 24 having one polarity, and the lead 30 contacts the bottom surface (as shown) of the battery 26 having the opposite polarity (FIGS. 4-8). To avoid any possibility that one or both the leads 28 and 30 might bend into contact with both portions of one or both batteries 24 and 26, respectively, and thereby short-circuit the batteries 24 and 26 by such unintentional contact, a small strip of electrical insulation tape (not shown) may be applied to the bottom surface of the battery 24 beneath the lead 28 and to the top surface or portion of the battery 26 above the lead 30. Located in this manner, the electrical insulation tape prevents the leads 28 and 30 from contacting the unintended surface or portion of each of the batteries 24 and 26.

The case cap 16 is attached to the case body 12 after the LED 14 and the batteries 24 and 26 have been inserted and retained within the interior space 18. Tabs 66 and 68, which extend from opposite sides of the case cap 16, snap fit into tab openings 70 and 72, respectively, each of which is formed on the sidewall 46 on opposite sides of the interior space 18. The connection of the tabs 66 and 68 into the tab openings 70 and 72 firmly retains the case 16 to the case body 12. However, if it is desired to remove the case cap 16, for example to replace the batteries 24 and 26, the tabs 66 and 68 can be depressed out of the tab openings 70 and 72 to allow the case cap 16 to be removed.

The case cap 16 also includes slide guides 74 and 76. The slide guides 74 and 76 define a movement path for the switch slide 20. The slide guides 74 and 76 extend from the interior surface of the case cap 16 into the interior space 18 on opposite sides of the rectangular opening 22. The slide guides 74 and 76 contact and partially encircle the transverse outer edges of the switch slide 20 to confine its movement along a path which projects between the vertically separated batteries 24 and 26 within the case body 16. The movement path of the switch slide 20 established by the slide guides 74 and 76 is generally parallel to the lower surface of the battery 24 and the upper surface of the battery 26. The slide guides 74 and 76 shield the bearing 32 from inadvertent contact with the batteries 24 and 26 when the switch slide 20 is in the open position (FIG. 5). The slide guides 74 and 76 also abut against the edges of the batteries 24 and 26 to retain and maintain the batteries 24 and 26 in a forward position within the case body 12 (FIGS. 5-7).

The inner end of the switch slide 20 includes a bore 78 (FIGS. 2, 3, 5-7 and 9) which retains the contact bearing 32. The sidewall of the bore 78 is formed concavely into the switch slide 20, as shown in FIG. 9, and this concavity retains the contact bearing 32 within the bore 78. The diameter of the bore 78 and the contact bearing 32 are approximately the same which allows the contact bearing 32 to be press-fitted into the bearing bore 78 while being held by the concave side walls of the bore 78. In this manner, the contact bearing 32 is permanently maintained in the bore 78 and connected to the switch slide 20.

The switch slide 20 is inserted into the rectangular opening 22 in the case cap 16, and then the contact bearing 32 is pressed into the bore 78. The diameter of the contact bearing 32 is larger than the narrowest transverse dimension of the rectangular opening 22. Any attempt to withdraw the inner end of switch slide 20 from the rectangular opening 22 is prevented, because the contact bearing 32 contacts the case cap 16 around the rectangular opening 22 when the switch slide 20 moves outward.

At the outer end of the switch slide 20 is a switch cap 80 which is slightly wider than the rectangular opening 22 in the case cap 16. The switch cap 80 prevents the switch slide 20 from being pushed completely within the interior space 18 of the case body 12 when the switch cap 80 comes in contact with the case cap 16.

The switch slide 20 is prevented from inadvertently moving from the extended position (FIGS. 1 and 5) to the depressed position (FIG. 7) due to a stop tang 82 formed as a part of the switch slide 20. The stop tang 82 normally deflects laterally from the switch slide 20 a sufficient distance to abut a forward edge 84 of the stop tang 82 against the case cap 16 (FIG. 5), when the switch slide 20 is attempted to be depressed towards the interior space 18 of the case body 12 from the extended position (FIG. 5). In order to depress the switch slide 20 (FIGS. 6 and 7), the stop tang 82 is deflected toward the plane of the switch slide 20 a sufficient amount so that the forward edge 84 of the stop tang 82 fits within the rectangular opening 22 of the case cap 16, as shown in FIG. 6. Once the forward edge 84 of the stop tang 82 has cleared the rectangular opening 22 in the case cap 16, force on the stop tang 82 is no longer required to continue to depress the switch slide 20. The user applies finger pressure to the stop tang 82 to deflect it when the user wishes to activate the accent light 10. To increase the strength of the stop tang 82 and increase the amount of finger pressure required to depress it, a gusset 85 or similar structure is added to the stop tang 82 where the stop tang 82 intersects with the switch slide 20 (FIGS. 3, 5-7).

As the switch slide 20 is depressed from the extended position shown in FIG. 5 to the intermediate position shown in FIG. 6, the contact bearing 32 comes into physical contact with the lower surface of battery 24 and the upper surface of battery 26, as shown in FIG. 6. The diameter of the contact bearing 32 is slightly greater than the distance between the lower surface of battery 24 and the upper surface of battery 26, when the contact bearing 32 is not in contact with the batteries 24 and 26. Continued movement of the switch slide 20 from the intermediate position shown in FIG. 6 to the depressed position shown in FIG. 7 forces the contact bearing 32 between the batteries 24 and 26 and slightly separates the batteries to establish a good electrical connection between the two batteries through the contact bearing 32. The bell-shaped sides 42 and 44 of the case body 12 deform slightly as the contact bearing 32 is inserted between the batteries, due to the battery 24 pushing upward against the ridges 58 and the LED lead 28 in the groove 55 (FIG. 4) while the battery 26 presses downward against the ridges 60 and the LED lead 30 in the groove 56 (FIG. 4). The force caused by slightly forcing the batteries 24 and 26 apart creates enough static friction on the contact bearing 32 to ensure that the switch slide 20 does not inadvertently move out of the depressed position shown in FIG. 7 without manual force applied by the user to the ring 40 of the switch slide 20.

When the contact bearing 32 is in physical contact with the batteries 26, a complete circuit is created through the contact bearing 32, the batteries 26, and the LED 14 (FIG. 8). The batteries 24 and 26 are positioned within the case body 12 such that the polarity of the batteries 26 is additive when the contact bearing 32 connects the batteries 24 and 26 in series. For example as shown in FIG. 8, the contact bearing 32 contacts the lower side of the battery 24, which could be its negative terminal, and also contacts the upper side of battery 26, which could be its positive terminal; and the upper side or positive terminal of the battery 24 is connected to the LED lead 28 and the lower side or negative terminal of the battery 26 is connected to the LED lead 30. The additive polarity of the batteries 24 and 26 from this series connection ensures appropriate voltage for operating the LED 14.

The structural features of the accent light 10 facilitate its easy and relatively inexpensive assembly. The LED 14 is first inserted into the interior space 18 of the case body 12 until its base portion 53 contacts the lip 54 of the annular protrusion 48. The leads 28 and 30 of the LED 14 are next positioned in the grooves 55 and 56. The batteries 24 and 26 are then inserted into the case body 12 with the desired orientation to achieve series electrical polarity. Insertion of the batteries retains the LED 14 in place because of contact with the leads 28 and 30 and simultaneously establishes a good electrical connection between the leads 28 and 30 and the batteries 24 and 26. The switch slide 20 is then inserted in the rectangular opening 22 of the case cap 16. The contact bearing 32 is then press fitted into the bore 78 to permanently retain the switch slide 20 to the case cap 16. The assembled case cap 16 and switch slide 20 are then attached to the case body 12 by pressing the tabs 66 and 68 into the tab openings 70 and 72.

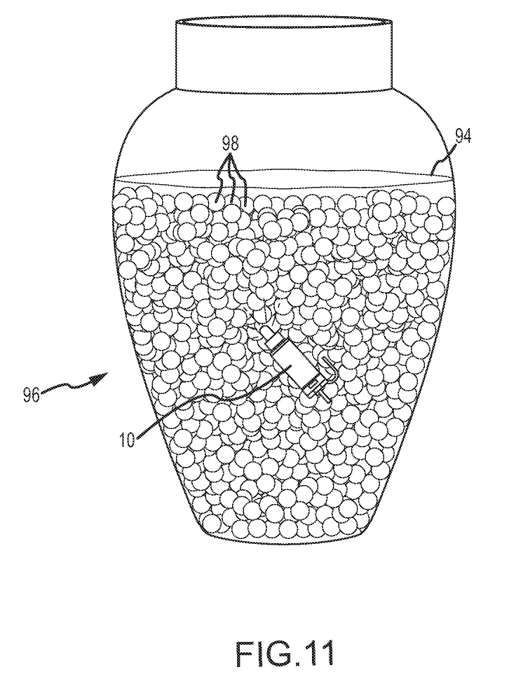

The accent light 10 thus assembled has a myriad of different uses. Exemplary uses are shown in FIGS. 10 and 11. As shown in FIG. 10, an accent light 10 is connected to an upper open edge 86 which defines a mouth of a vase 88. A flower arrangement 90 is positioned within the vase 88. Water 92 for the flower arrangement 90 is in the bottom of the vase 88. Light from the energized LED 14 shines downward on the water 92 and within the vase 88 to create a visual accent that highlights the appearance of the flower arrangement 90 and vase 88. Another accent light 10 is attached to the flower arrangement 90 itself, as is also shown in FIG. 10. The hook 34 (FIG. 1) connects the accent light 10 to a stem of one of the flowers of the arrangement 90, for example.

Another exemplary use is illustrated in FIG. 11. The accent light 10 is submerged in water 94 within a vase 96. The accent light 10 may be concealed within art objects, such as marbles 98, also submerged within the water 94, or the accent light can be used by itself within the water 94 in the vase 96. The light from the activated accent light 10 illuminates the water within the vase 96 and highlights the appearance of the vase 96 and its marbles 98.

It has been discovered that the accent light 10 will function adequately even when submerged in water, and even though the case body 12 is not watertight. Although the reasons for such functionality are not completely understood, the water within the space between the batteries 24 and 26 does not appear to significantly short-circuit the current flow through the leads 28 and 30 to the LED 14. Some current flow does apparently leak through the water, because the normal lifetime of use of the accent light 10 in water is about two-thirds of the normal lifetime of use when the accent light 10 is used in an air environment.

A number of significant advantages and improvements are available from the accent light 10. The accent light 10 has a structure which significantly facilitates its assembly. The accent light 10 can be assembled in about 20-30 seconds, thereby reducing its manufacturing costs. The reduced assembly results in lower manufacturing costs, which in turn should result in less cost to the consumer. The case body 12, the case cap 16, and the switch slide 20 are preferably formed by plastic injection molding. Plastic injection molding permits mass production of precise parts at a minimal cost. The LED 14, the batteries 24 and 26 and the contact bearing 32 are all commercially available components which are relatively inexpensive to purchase in mass quantities. The accent light 10 can be selectively activated and deactivated by moving the switch slide 20 between the closed and open positions, thereby allowing the user to activate the accent light 10 when desired and to deactivate the accent light when it is no longer desired for use. Using the accent light 10 only when desired has the beneficial effect of prolonging its usable lifetime before the electrical energy from the batteries 24 and 26 is depleted. The batteries 24 and 26 are also replaceable when depleted, by removing the case cap 16 to gain access to the batteries 24 and 26. In a similar manner, the LED 14 is also replaceable, but the typical LED 14 has a very long usable lifetime and will not normally require replacement.

The accent light 10 can also be used in an activated condition when submerged under water. A submersible operative capability increases the number of potential uses beyond those only in an air environment. The accent light 10 is easily attached to decorations by use of the hook 34, the opening 38 in the hook 34, and the ring 40 in the switch slide 20. Great versatility for using the accent light 10 results from its features, leading to many opportunities for new and unusual visual accents and effects. These and other improvements and advantages will be more apparent after fully comprehending the aspects of the present invention.

A presently preferred embodiment of the invention and many of its improvements have been described above with a degree of particularity. The particularly of this description is to facilitate a complete understanding of a preferred example of the invention, and is not necessarily intended to limit the scope of the invention. The scope of the invention is defined by the following claims.

What is claimed:

1. An accent light, comprising:
a case body defining an interior space;
an LED retained by the case body, the LED having two contact leads positioned within the interior space;
two batteries positioned within the interior space of the case body in a spaced apart relationship, each battery having spaced apart opposing surfaces of opposite polarity, one surface of each battery in contact with a different one of the contact leads of the LED, the other surfaces of each battery occupying an opposed spaced apart relationship with one another;
a switch moveably connected to the case body and including a contact bearing, the switch moveable between an open position and a closed position, the open position locating the contact bearing out of electrical contact with the spaced apart opposing surfaces of the batteries, the closed position locating the contact bearing in electrical contact with the spaced apart opposing surfaces of the batteries to complete an electrical circuit through the contact bearing, the batteries, and the leads of the LED to deliver electrical power from the batteries to illuminate the LED.

2. An accent light as defined in claim 1, wherein:
movement of the switch into the closed position inserts the contact bearing into the space between the spaced apart opposing surfaces of the batteries.

3. An accent light as defined in claim 2, further comprising:
projections extending inward from a surface of the case body within the interior space of the case body, the projections separating the batteries from one another, the projections further maintaining contact of the surfaces of the batteries with the leads of the LED; and wherein:
the space between the spaced apart opposing surfaces of the batteries is less than a transverse dimension of the contact bearing when the switch is in the open position.

4. An accent light as defined in claim 3, wherein:
insertion of the contact bearing into the space between the spaced apart opposing surfaces of the batteries separates the spaced apart opposing surfaces of the batteries from one another relative to the space between the opposing spaced apart surfaces of the batteries when the switch is in the open position.

5. An accent light as defined in claim 3, wherein:
the case body includes spacers formed on an inside surface of the case body and extending toward the batteries, the spacers contacting the surfaces of the batteries which contact the leads of the LED.

6. An accent light as defined in claim 5, wherein:
each surface of each battery is contacted by a set of spacers; and
the lead of the LED contacted by the surface of each battery extends between the spacers of the set of spacers which contact the same surface of the battery.

7. An accent light as defined in claim 6, wherein:
the case body includes a groove formed on the inside surface of the case body between the spacers of each set of spacers, each groove receiving a lead of the LED to maintain the lead of the LED in position to contact the surface of each battery.

8. An accent light as defined in claim 7, wherein:
the case body is formed of molded plastic; and
the case body deforms when the switch is moved into the closed position as a result of the contact bearing inserted between the opposing spaced apart surfaces increasing a dimension between the opposing spaced apart surfaces of the batteries.

9. An accent light as defined in claim 1, further comprising:
a case cap connected to the case body and closing the interior space;
an opening defined within the case cap; and wherein:
the switch comprises a elongated switch slide which extends through the opening and which is movable by sliding relative to the opening to an extended position when the switch is in the open position and which is movable by sliding to a depressed position when the switch is in the closed position.

10. An accent light as defined in claim 9, wherein:
the contact bearing is retained at an inner end of the switch slide.

11. An accent light as defined in claim 10, wherein:
the contact bearing is spherical;
the inner end of the switch slide includes a bore for retaining the contact bearing.

12. An accent light as defined in claim 11, wherein:
the inner surface of the bore is concavely shaped;
the contact bearing is press fit into the contact bearing bore; and
the concave shape of the inner surface of the bore interacts with the spherical surface of the contact bearing to permanently retain the contact bearing in the bore.

13. An accent light as defined in claim 9, wherein:
the switch slide includes a stop tang which deflects transversely outward from the switch slide in a normal position and which is manually moveable into a deflected position which is generally in alignment with the switch slide;
the stop tang includes a forward edge which contacts the case cap at a position adjacent to the opening to prevent movement of the switch slide from the extended position to the depressed position while the stop tang is in its normal position; and
movement of the stop tang to the deflected position locates the forward edge of the stop tang within the opening to allow movement of the switch slide from the extended position to the depressed position.

14. An accent light as defined in claim 9, wherein:
the case Includes guides extending toward the interior space from locations on opposite sides of the opening in the case cap; and
the guides orient the switch slide to insert the contact bearing in the space between the spaced apart opposed surfaces of the batteries when the switch switch slide is moved from the extended position to the depressed position.

15. An accent light as defined in claim 9, wherein:
the switch slide includes a ring formed at an exterior end of the switch slide, the ring defining a space within which to insert a retainer for supporting the accent light.

16. An accent light as defined in claim 1, further comprising:
a hook extending from the case body and defining a space within which to confine a structure for supporting the accent light.

17. An accent light as defined in claim 15, wherein:
the hook includes a retaining opening formed therein through which to insert a retainer for supporting the accent light.

18. A method of activating an accent light having two spaced apart batteries which are connected to supply electrical power to an LED, the batteries each having exterior surfaces, one surface of each battery occupying a spaced apart opposing relationship with the surface of the other battery, the method comprising:
selectively inserting a conductive contact bearing between the spaced apart opposing surfaces of the batteries to complete an electrical circuit through the batteries by which to conduct the electrical power to the LED; and
selectively withdrawing the contact bearing from between the spaced apart opposing surfaces of the batteries to open the electrical circuit through the batteries by which to discontinue conducting electrical power to the LED.

19. A method as defined in claim 18, wherein the batteries are confined within a case body and the contact bearing is connected to an elongated switch slide which extends into the case body, the method further comprising:
depressing the switch slide longitudinally into the case body to insert the contact bearing between the spaced apart opposing surfaces of the batteries; and
extending the switch slide longitudinally from the case body to withdraw the contact bearing from between the spaced apart opposing surfaces of the batteries.

20. A method of using an accent light having two spaced apart batteries which are connected to supply electrical power to an LED to illuminate the LED, the batteries and the LED connected to a case body which is not sealed, the method comprising:
submerging the accent light within water while the batteries supply electrical power to sufficient to illuminate the LED;
permitting water to enter the case body and surround the batteries and the LED while the batteries supply electrical power to the LED; and
illuminating the LED from power supplied by the batteries while they accent light is submerged for a predetermined amount of time greater than the amount of time that the batteries would supply electrical power if those batteries were electrically short-circuited.
